(19) United States
(12) Patent Application Publication
(10) Pub. No.: US 2012/0282558 A1
(43) Pub. Date: Nov. 8, 2012

(54) COMBUSTOR NOZZLE AND METHOD FOR SUPPLYING FUEL TO A COMBUSTOR

(75) Inventors: Gilbert Otto Kraemer, Greer, SC (US); Jonathan Dwight Berry, Simpsonville, SC (US); Jason Randolph Marshall, Moore, SC (US)

(73) Assignee: GENERAL ELECTRIC COMPANY, Schenectady, NY (US)

(21) Appl. No.: 13/101,530

(22) Filed: May 5, 2011

(51) Int. Cl. F23M 3/00; B05B 1/34; B05B 1/26

(52) U.S. Cl. 431/9; 239/544; 239/466

(57) ABSTRACT

A combustor nozzle includes a fuel supply in fluid communication with a fuel passage that terminates at a fuel outlet. An oxidant supply is in fluid communication with an oxidant passage radially displaced from the fuel passage and that terminates at an oxidant outlet radially displaced from the fuel outlet. A diluent passage radially displaced from the fuel passage and the oxidant passage terminates at a diluent outlet disposed between the fuel outlet and the oxidant outlet. A method for supplying fuel to a combustor includes flowing the fuel through a fuel outlet and flowing an oxidant through an oxidant outlet radially displaced from the fuel outlet. The method further includes flowing a diluent through a diluent outlet radially disposed between the fuel outlet and the oxidant outlet.

### FIELD OF THE INVENTION

The present invention generally involves a combustor nozzle and a method for supplying fuel to a combustor. In particular embodiments of the present invention, the combustor nozzle delays blending of a fuel and an oxidant in the combustor to reduce the temperature proximate to the combustor nozzle.

### BACKGROUND OF THE INVENTION

Combustors are commonly used in industrial and power generation operations to ignite fuel to produce combustion gases having a high temperature and pressure. For example, gas turbines typically include one or more combustors to generate power or thrust. A typical gas turbine used to generate electrical power includes an axial compressor at the front, one or more combustors around the middle, and a turbine at the rear. Ambient air may be supplied to the compressor, and rotating blades and stationary vanes in the compressor progressively impart kinetic energy to the working fluid (air) to produce a compressed working fluid at a highly energized state. The compressed working fluid exits the compressor and flows through one or more nozzles in each combustor where the compressed working fluid mixes with fuel and ignites to generate combustion gases having a high temperature and pressure. The combustion gases expand in the turbine to produce work. For example, expansion of the combustion gases in the turbine may rotate a shaft connected to a generator to produce electricity.

In some gas turbine applications, a working fluid other than ambient air may be supplied to the compressor, resulting in compressed working fluid produced by the compressor that is oxygen deficient. For example, in oxy-fuel or stoichiometric exhaust gas recirculation (SEGR) applications, a portion of the exhaust from the turbine may be supplied as the working fluid to the compressor, and the compressed working fluid supplied to the combustor may therefore be oxygen deficient. As a result, an oxidant may be separately supplied to the combustor to directly mix with the fuel prior to combustion.

It is widely known that the thermodynamic efficiency of a gas turbine increases as the operating temperature, namely the combustion gas temperature, increases. However, if the fuel and oxidant are not evenly mixed prior to combustion, localized hot spots may form in the combustor near the nozzle exits. The localized hot spots may decrease life and increase the production of nitrous oxides in the fuel rich regions, while the fuel lean regions may increase the production of carbon monoxide and unburned hydrocarbons, all of which are undesirable exhaust emissions. In addition, the fuel rich regions may increase the chance for the flame in the combustor to flash back into the nozzles and/or become attached inside the nozzles which may damage the nozzles. Although flame flash back and flame holding may occur with any fuel, they occur more readily with high reactive fuels, such as hydrogen, that have a higher burning rate and a wider flammability range. Therefore, continued improvements in the combustor nozzle designs and methods for supplying fuel to the combustor would be useful to improve combustor efficiency, reduce undesirable emissions, and/or prevent flash back and flame holding events.

### BRIEF DESCRIPTION OF THE INVENTION

Aspects and advantages of the invention are set forth below in the following description, or may be obvious from the description, or may be learned through practice of the invention.

One embodiment of the present invention is a combustor nozzle that includes a fuel supply in fluid communication with a fuel passage that terminates at a fuel outlet. An oxidant supply is in fluid communication with an oxidant passage radially displaced from the fuel passage and that terminates at an oxidant outlet radially displaced from the fuel outlet. A diluent passage radially displaced from the fuel passage and the oxidant passage terminates at a diluent outlet disposed between the fuel outlet and the oxidant outlet.

Another embodiment of the present invention is a combustor nozzle that includes an axial centerline. A center body is aligned with the axial centerline and defines a fuel passage through at least a first portion of the nozzle. An outer shroud circumferentially surrounds at least a first portion of the center body and defines an oxidant passage through at least a second portion of the nozzle. An oxidant supply is in fluid communication with the oxidant passage. An intermediate shroud is connected to the center body, extends along at least a second portion of the center body, and defines a diluent passage between the fuel passage and the oxidant passage.

The present invention also includes a method for supplying fuel to a combustor that includes flowing the fuel through a fuel outlet and flowing an oxidant through an oxidant outlet radially displaced from the fuel outlet. The method further includes flowing a diluent through a diluent outlet radially disposed between the fuel outlet and the oxidant outlet.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a simplified cross-section view of a combustor according to one embodiment of the present invention;

FIG. 2 is a downstream axial plan view of the combustor shown in FIG. 1 taken along line A-A;

FIG. 3 is an enlarged downstream view of a nozzle shown in FIG. 2;

FIG. 4 is a simplified cross-section view of the nozzle shown in FIG. 2 taken along line B-B; and

FIG. 5 is a simplified cross-section view of the nozzle shown in FIG. 2 taken along line B-B according to an alternate embodiment.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

Various embodiments of the present invention provide a combustor nozzle and a method for supplying fuel to a combustor. In particular embodiments of the present invention, the combustor nozzle may be incorporated into an oxy-fuel or stoichiometric exhaust gas recirculation (SEGR) combustor. Specifically, a fuel, a diluent, and an oxidant may be supplied to a combustion chamber through a plurality of substantially concentric or co-axial fluid passages in the combustor nozzle so that the diluent may delay blending of the fuel and oxidant in the combustion chamber. Computational fluid dynamic models indicate that the delay in the blending of the fuel and oxidant produces a corresponding delay in the combustion of the fuel and oxidant, thereby reducing the temperature proximate to the combustor nozzle, reducing undesirable emissions from the combustor, and/or reducing flame holding events. Although described generally in the context of a combustor nozzle incorporated into a combustor of a gas turbine, embodiments of the present invention may be applied to any combustor and are not limited to a gas turbine combustor unless specifically recited in the claims.

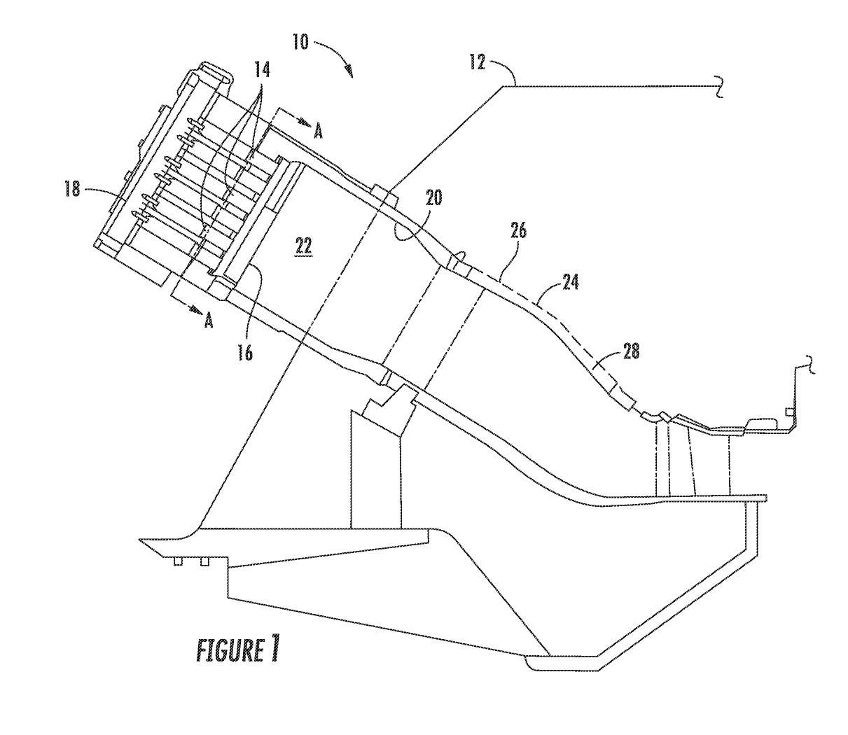

FIG. 1 shows a simplified cross-section view of an exemplary combustor 10, such as would be included in a gas turbine, according to one embodiment of the present invention. A casing 12 may surround the combustor 10 to contain the compressed working fluid flowing to the combustor 10. As shown, the combustor 10 may include one or more nozzles 14 radially arranged in a top cap 16. An end cover 18 and a liner 20 generally surround a combustion chamber 22 located downstream from the nozzles 14. As used herein, the terms “upstream” and “downstream” refer to the relative location of components in a fluid pathway. For example, component A is upstream of component B if a fluid flows from component A to component B. Conversely, component B is downstream of component A if component B receives a fluid flow from component A. A flow sleeve 24 with flow holes 26 may surround the liner 20 to define an annular passage 28 between the flow sleeve 24 and the liner 20. The compressed working fluid may pass through the flow holes 26 in the flow sleeve 24 to flow along the outside of the liner 20 to provide film or convective cooling to the liner 20. When the compressed working fluid reaches the end cover 18, the compressed working fluid reverses direction to flow through the one or more nozzles 14 where it mixes with fuel before igniting in the combustion chamber 22 to produce combustion gases having a high temperature and pressure. Liner 20 may also have openings therethrough to enable cooling of the flame side wall, such as by film cooling, effusion cooling, or other methods.

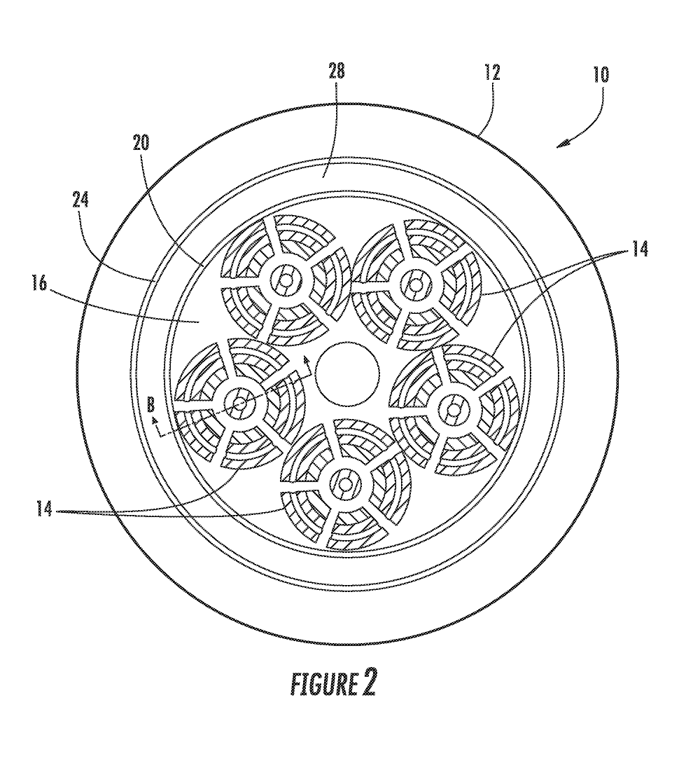

FIG. 2 provides a downstream axial plan view of the combustor 10 shown in FIG. 1 taken along line A-A. Various embodiments of the combustor 10 may include different numbers and arrangements of nozzles. For example, in the embodiment shown in FIG. 2, the combustor 10 includes five nozzles 14 radially arranged in the top cap 16. As previously described with respect to FIG. 1, the working fluid flows through the annular passage 28 (out of FIG. 2) between the flow sleeve 24 and the liner 20 until it reaches the end cover 18 where it reverses direction to flow through the nozzles 14 and into the combustion chamber 22 (into FIG. 2).

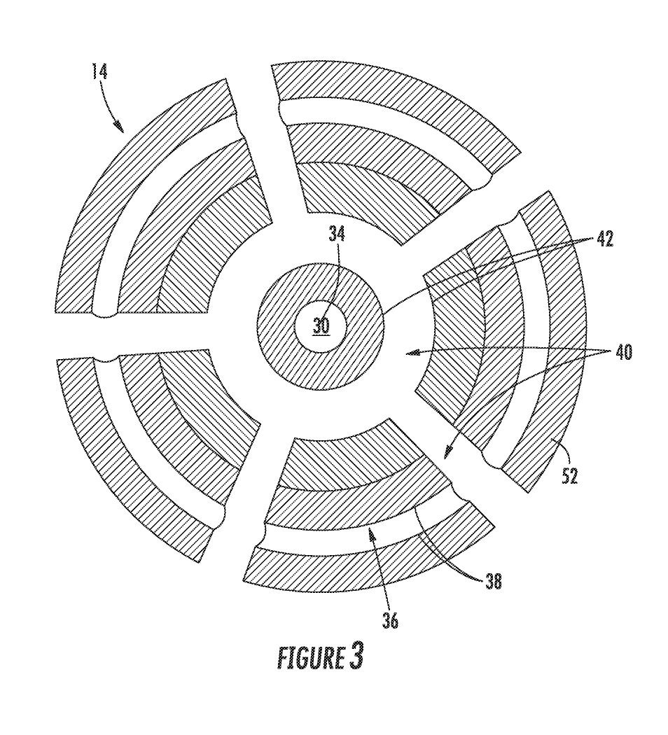

FIG. 3 provides an enlarged downstream view of the nozzle 14 shown in FIG. 2. As shown, each nozzle 14 may include a plurality of substantially concentric or co-axial fluid passages that provide fluid communication through the nozzle 14 and into the combustion chamber 22. For example, a fuel passage 30 may be substantially aligned with an axial centerline 32 of the nozzle 14 and terminate at a fuel outlet 34. Possible fuels supplied through the fuel passage 30 may include, for example, blast furnace gas, carbon monoxide, coke oven gas, natural gas, methane, vaporized liquefied natural gas (LNG), hydrogen, syngas, butane, propane, olefins, and combinations thereof. An oxidant passage 36 may circumferentially surround at least a portion of the fuel passage 30 and terminate at an oxidant outlet 38. The oxidant supplied through the oxidant passage 36 may comprise virtually any oxygen rich fluid, such as pure oxygen (O₂) or oxygen containing compounds such as nitrogen tetroxide (N₂O₄), hydrogen peroxide (H₂O₂), and combinations thereof. A diluent passage 40 may extend through a portion of the oxidant passage 36 and circumferentially surround at least a portion of the fuel passage 30 before terminating at a diluent outlet 42. Possible diluents supplied through the diluent passage 40 may include water, steam, fuel additives, various inert gases such as nitrogen and/or various non-flammable gases such as carbon dioxide or combustion exhaust gases supplied to the combustor 10 from the compressor (not shown). In this manner, the fuel and oxidant passages 30, 36 may provide fluid communication from the end cover 18 into the combustion chamber 22, and the diluent passage 40 may provide fluid communication through at least a portion of the oxidant passage 36 and into the combustion chamber 22. In addition, the fuel, oxidant, and diluent passages 30, 36, 40 and their associated outlets 34, 38, 42 may be radially displaced from one another, with the diluent outlet 42 radially disposed between the fuel outlet 34 and the oxidant outlet 38.

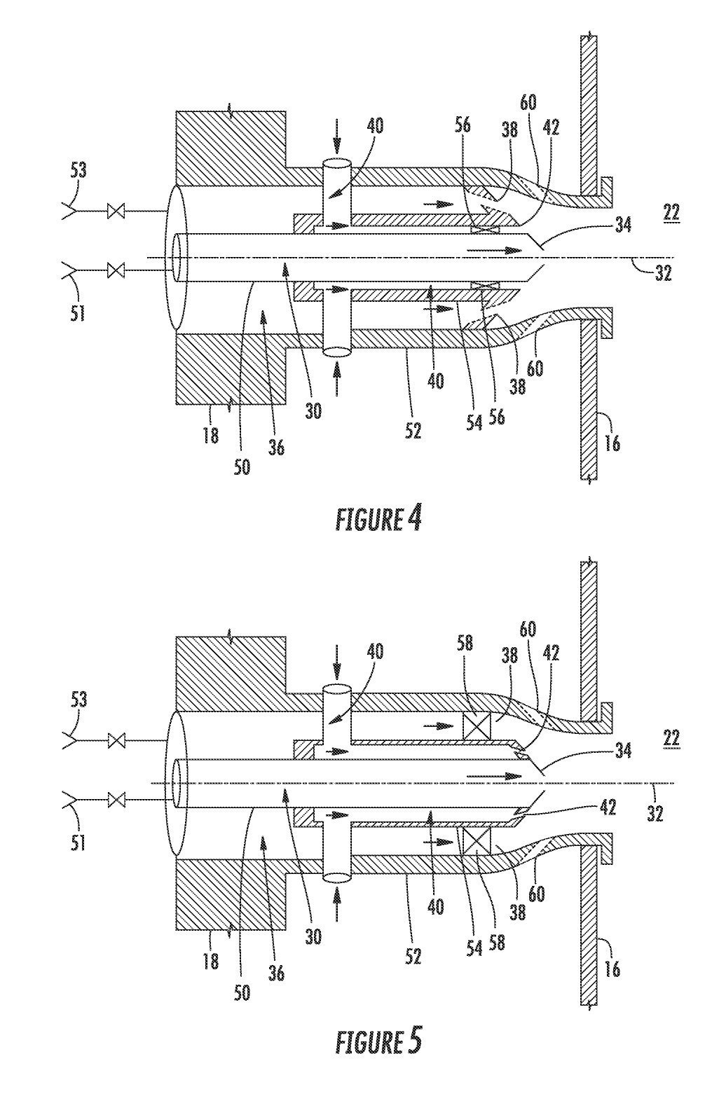

FIGS. 4 and 5 provide simplified cross-section views of the nozzle 14 shown in FIG. 2 taken along line B-B according to various embodiments of the present invention. A center body 50 may be aligned with the axial centerline 32 of the nozzle 14, and the center body 50 may define the fuel passage 30 through at least a first portion of the nozzle 14. The center body 50 may extend through the end cover 18 to provide fluid communication for a fuel supply 51 through the end cover 18 and into the combustion chamber 22. An outer shroud 52 may circumferentially surround at least a first portion of the center body 50 to define the oxidant passage 36 through at least a second portion of the nozzle 14 between the center body 50 and the outer shroud 52. The oxidant passage provides fluid communication for an oxidant supply 53 through the end cover 18 and into the combustion chamber 22. An intermediate shroud 54 may be connected to the center body 50 and may extend along at least a second portion of the center body 50. In this manner, the intermediate shroud 54 may define at least a portion of the diluent passage 40 radially between the fuel passage 30 and the oxidant passage 36. In addition, as shown in FIGS. 4 and 5, a portion of the diluent passage 40 may extend through the intermediate shroud 54, the oxidant passage 36, and the outer shroud 52 to provide fluid communication for the diluent through the nozzle 14 and into the combustion chamber 22.

As further shown in FIGS. 4 and 5, one or more of the fuel passage 30, oxidant passage 36, and/or diluent passage 40 may include a plurality of swirler vanes or angled outlet ports to impart swirl to the fluid flowing through the respective passage. For example, as shown in FIG. 4, the oxidant outlet 38 may be angled with respect to the axial centerline 32 to impart swirl to the oxidant exiting the nozzle 14 and entering the combustion chamber 22. Similarly, the diluent passage 40 and/or diluent outlet 42 may include a plurality of diluent swirler vanes 56 to impart swirl to the diluent exiting the nozzle 14 and entering the combustion chamber 22. Alternately, as shown in FIG. 5, the oxidant passage 36 and/or oxidant outlet 38 may include a plurality of oxidant swirler vanes 58 to impart swirl to the oxidant exiting the nozzle 14 and entering the combustion chamber 22, and the diluent outlet 42 may be angled with respect to the axial centerline 32 to impart swirl to the diluent exiting the nozzle 14 and entering the combustion chamber 22.

In particular embodiments, as shown in FIGS. 4 and 5, the outer shroud 52 may further include one or more diluent ports 60 through the outer shroud 52 that provide fluid communication for the diluent through the outer shroud 52. In this manner, the diluent flowing through the diluent passage 40 may effectively form a diluent curtain between the fuel and highly reactive oxidant exiting the respective fuel and oxidant outlets 34, 38 to delay mixing and thus combustion of the fuel and oxidant proximate to the various nozzle outlets 34, 38, 42. In addition, the diluent flowing through the diluent ports 60 near the nozzle 14 exit may disrupt the diluent curtain to promote mixing of the fuel and oxidant entering the combustion chamber 22. As a result, computational fluid dynamic models indicate that the delay in the blending of the fuel and oxidant reduces the temperature proximate to the nozzle 14, reduces undesirable emissions from the combustor 10, and/or reduces flame holding events. Although FIGS. 1-5 illustrate the fuel passage 30 radially aligned with the centerline 32 of the nozzle 14 and the oxidant passage 36 radially outward of the fuel passage 30, the relative radial locations of the fuel and oxidant passages 30, 36 is not a limitation of the present invention unless specifically recited in the claims. For example, one of ordinary skill in the art can readily appreciate that in alternate embodiments the oxidant passage 36 may be radially aligned with the centerline 32 of the nozzle 14 and the fuel passage 30 may be radially outward of the oxidant passage 36, and further illustration of alternate arrangements is not necessary to understand or enable the various embodiments.

The various embodiments described and illustrated with respect to FIGS. 1-5 may further provide a method for supplying fuel to the combustor 10. The method may include flowing the fuel through the fuel outlet 34 and flowing the oxidant through the oxidant outlet 38 radially displaced (i.e., radially inside or outside) from the fuel outlet 34. The method may further include flowing the diluent through the diluent outlet 42 radially disposed between the fuel outlet 34 and the oxidant outlet 38. In particular embodiments, the method may further include swirling the fuel, oxidant, and/or diluent flowing through the nozzle 14 and/or flowing the diluent through the outer shroud 52 circumferentially surrounding the nozzle 14.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A combustor nozzle comprising:
a. a fuel supply in fluid communication with a fuel passage, wherein the fuel passage terminates at a fuel outlet;
b. an oxidant supply in fluid communication with an oxidant passage radially displaced from the fuel passage, wherein the oxidant passage terminates at an oxidant outlet radially displaced from the fuel outlet; and
c. a diluent passage radially displaced from the fuel passage and the oxidant passage, wherein the diluent passage terminates at a diluent outlet disposed between the fuel outlet and the oxidant outlet.

2. The combustor nozzle as in claim 1, wherein the fuel outlet is axially aligned with an axial centerline of the nozzle.

3. The combustor nozzle as in claim 1, wherein at least a portion of the diluent passage circumferentially surrounds at least a portion of the fuel passage.

4. The combustor nozzle as in claim 1, wherein at least a portion of the oxidant passage circumferentially surrounds at least a portion of the diluent passage.

5. The combustor nozzle as in claim 1, wherein the oxidant outlet comprises a plurality of oxidant swirler vanes.

6. The combustor nozzle as in claim 1, wherein the oxidant outlet is angled with respect to an axial centerline of the nozzle.

7. The combustor nozzle as in claim 1, wherein the diluent outlet comprises a plurality of diluent swirler vanes.

8. The combustor nozzle as in claim 1, further comprising an outer shroud circumferentially surrounding at least a portion of the oxidant passage and a diluent port through the outer shroud that provides fluid communication for a diluent through the shroud.

9. The combustor nozzle as in claim 1, wherein at least a portion of the diluent passage extends through the oxidant passage.

10. A combustor nozzle comprising:
a. an axial centerline;
b. a center body aligned with the axial centerline, wherein the center body defines a fuel passage through at least a first portion of the nozzle;
c. an outer shroud circumferentially surrounding at least a first portion of the center body, wherein the outer shroud defines an oxidant passage through at least a second portion of the nozzle;
d. an oxidant supply in fluid communication with the oxidant passage; and
e. an intermediate shroud connected to the center body and extending along at least a second portion of the center body, wherein the intermediate shroud defines a diluent passage between the fuel passage and the oxidant passage.

11. The combustor nozzle as in claim 10, further comprising a plurality of oxidant swirler vanes in the oxidant passage.

12. The combustor nozzle as in claim 10, wherein the oxidant passage terminates at an oxidant outlet angled with respect to the axial centerline.

13. The combustor nozzle as in claim 10, further comprising a plurality of diluent swirler vanes in the diluent passage.

14. The combustor nozzle as in claim 10, further comprising a diluent port through the outer shroud that provides fluid communication for a diluent through the outer shroud.

15. The combustor nozzle as in claim 10, wherein at least a portion of the diluent passage extends through the oxidant passage and the outer shroud.

16. A method for supplying fuel to a combustor comprising:
a. flowing the fuel through a fuel outlet;
b. flowing an oxidant through an oxidant outlet radially displaced from the fuel outlet; and
c. flowing a diluent through a diluent outlet radially disposed between the fuel outlet and the oxidant outlet.

17. The method as in claim 16, further comprising flowing the oxidant through the oxidant outlet radially outward from the fuel outlet.

18. The method as in claim 16, further comprising swirling the oxidant flowing through the oxidant outlet.

19. The method as in claim 16, further comprising swirling the diluent flowing through the diluent outlet.

20. The method as in claim 16, further comprising flowing the diluent through an outer shroud circumferentially surrounding the nozzle.
